(19) United States
(12) Patent Application Publication
(10) Pub. No.: US 2021/0084020 A1
(43) Pub. Date: Mar. 18, 2021

(54) SYSTEM AND METHOD FOR IDENTITY AND AUTHORIZATION MANAGEMENT

(71) Applicant: Agilicus Inc., Kitchener (CA)

(72) Inventors: Kyle LAROSE, Waterloo (CA); Donald BOWMAN, Waterloo (CA); Michael MARCHETTI, Cambridge (CA)

(21) Appl. No.: 17/024,053

(22) Filed: Sep. 17, 2020

Related U.S. Application Data
(60) Provisional application No. 62/901,358, filed on Sep. 17, 2019.

(51) Int. Cl. H04L 29/06

(52) U.S. Cl. CPC H04L 63/0807; H04L 2463/082; H04L 63/102; H04L 63/0227

(57) ABSTRACT

A system for identity and authorization management of users of remote applications on a computer network, the system including: an Identity, Application and role-aware enrichment module configured to determine and authenticate an identity of a user and issue an access token; an Identity, Application and Role-Aware enforcement module configured to determine access to at least one application and provide access to the user based on the access token; a database configured to store authorization roles associated with the identity of the user and the at least one application; and a database configured to store rules associated with the authorization roles.

### RELATED APPLICATIONS

This application claims priority to U.S. Provisional Patent Application No. 62/901,358 filed Sep. 17, 2019, which is hereby incorporated in its entirety herein.

### FIELD

The present disclosure relates generally to networked computer applications. More particularly, the present disclosure relates to a system and method for identity and authorization management.

### BACKGROUND

Online and remote access to computer applications is becoming common. Further, modern applications are becoming more commonly available and accessible over a network. This network may be an internal corporate network, accessed by being connected physically or via a virtual private network, or, it may be a public Internet.

To be safe and secure, applications must ensure that only authenticated users perform actions for which they are authorized to perform. Authorized users may include both humans and other computer systems. In particular, humans may perform actions directly, or actions may be performed on behalf of a human user by another computer system, or, may be computer to computer actions.

Applications may in turn have more than one component, and these network connections may also require authentication and authorization for safety and security

As such, it is therefore desirable to have improved systems and methods for identity and authorization management.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a system for identity and authorization management of remote applications on a computer network, the system including: an Identity, Application and role-aware enrichment module configured to determine and authenticate an identity of a user and issue an access token; an Identity, Application and Role-Aware enforcement module configured to determine access to at least one application and provide access to the user based on the access token; a database configured to store authorization roles associated with the identity of the user and the at least one application; and a database configured to store rules associated with the authorization roles.

In some cases, the access token may include the identity of the user and the authorization roles associated with the user.

In some cases, the identity of the user and the user authorization roles may include a cryptographically confirmed access token.

In some cases, the system may further include a second factor authentication module configured to issue an authentication challenge based on the identity of the user.

In some cases, the system may further include an application aware firewall, wherein the firewall may include rules associated with one or more of HTTP method, path, parameters, HTTP headers, HTTP client certificate, and message body.

In some cases, the system may further include an application aware firewall, wherein the firewall may include rules associated with remote procedure call applications and methods, parameters, and body associated with the remote procedure call applications.

In some cases, the system may further include an identity aware firewall, wherein the firewall may be configured to provide a plurality of levels of access to the user based on the identity of the user and the user authorization roles.

In some cases, the at least one application may be configured to use network services; and the system may further include: a database configured to store network services authorization rules associated with each of the at least one applications; and a workload-aware firewall configured to receive a request from the at least one application to access network services and to control access between the at least one application and the network services based on the identity of the user and the user authorization roles.

In another aspect, there is provided a further system for identity and authorization management, the system including: at least one application, accessible to a user via a computer network, wherein the at least one application is configured to use network services; a database configured to store network services authorization rules associated with each of the at least one applications; and a workload-aware firewall configured to receive a request from the at least one application to access network services and to control access between the at least one application and the network services.

In some cases, the request may be a cryptographically-confirmed token.

In some cases, the system may further include a workload-aware firewall which may be configured to control access to the at least one application and the network services based on a user identity and authorization data associated with the request from the at least one application.

In some cases, the workload-aware firewall may be configured to control access to the at least one application and the network services based on a user identity and the authorization rules associated with the at least one application.

In still another aspect, there is provided a method for identity and authorization management, the method including: receiving, via a user, a request to access at least one application; determining an identity of the user; authenticating the identity of the user by providing an access token associated with the request; determining at least one role associated with the authenticated identity of the user; determining whether any rules are associated with the access of the at least one application, based on the identity of the user and the associated role of the user; and providing access to the at least one application based on the identity of the user and the associated roles and rules.

In some cases, the access token may include the identity of the user and the authorization roles associated with the user.

In some cases, the identity of the user and the user authorization roles may be included as cryptographically confirmed access token.

In some cases, authenticating the user may include issuing an authentication challenge based on the identity of the user.

In some cases, the method may further include: receiving a second request from the at least one application to access at least one network service; determining whether there is further user identity information to be added to the second request; determine whether there are any network service authorization rules associated with the request; and providing access to the at least one network service based on the application and associated authorization rules.

In some cases, the second request includes a cryptographically-confirmed token.

In some cases, providing of access may be further based on the authorization data of the user.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates a traditional data center deployment;

FIG. 2 illustrates an overview of a system for identity and authorization management interactions with its environment, according to an example embodiment;

FIGS. 3A and 3B are a sequence diagram illustrating how identity may be provided, according to an example embodiment;

FIG. 4 is a sequence diagram illustrating how user and role based authorizations could be evaluated, according to an example embodiment;

FIG. 5 is a sequence diagram illustrating how application workload identity and authorization could be evaluated, according to an example embodiment;

FIG. 6 illustrates details of how user identity, roles-based authorization may be applied to a web-based application, according to an example embodiment;

FIG. 7 illustrates an Identity, Application, Role-Aware Enrichment System, according to an example embodiment;

FIG. 8 illustrates an Identity, Application, Role-Aware Enforcement System, according to an example embodiment;

FIG. 9 illustrates a method for identity and authentication management according to an embodiment; and

FIG. 10 illustrates a method for identity and authentication management according to another embodiment.

### DETAILED DESCRIPTIONS

In the following, various example systems and methods will be described herein to provide example embodiment(s). It will be understood that no embodiment described below is intended to limit any claimed invention. The claims are not limited to systems, apparatuses or methods having all of the features of any one embodiment or to features common to multiple or all of the embodiments described herein. A claim may include features taken from any embodiment as would be understood by one of skill in the art. The applicants, inventors or owners reserve all rights that they may have in any invention disclosed herein, for example the right to claim such an invention in a continuing or divisional application and do not intend to abandon, disclaim or dedicate to the public any such invention by its disclosure in this document.

Generally, the present disclosure provides a method and system for identity and authorization management, in particular for network enabled or online computer applications. In particular, embodiments of the system and method are configured to receive a request for access to an application or an application request to access network services or application backend services. The system is configured to verify the identity of the user of the request and provide for further authentication of the user, via for example, second factor authentication. The request may be enriched by, for example a signed cryptographic access token, which is intended to show that the user's identity has been verified and authenticated. The system is also configured to determine at least one role that may be associated with the user as well as any rules that may be associated with the role of the user and the application the user wishes to access. The system is configured to provide access to the application based on the roles and associated rules. In some cases, the system is further intended to authorize an application's access to backend services, and may verify and authenticate this access based on the application and the user.

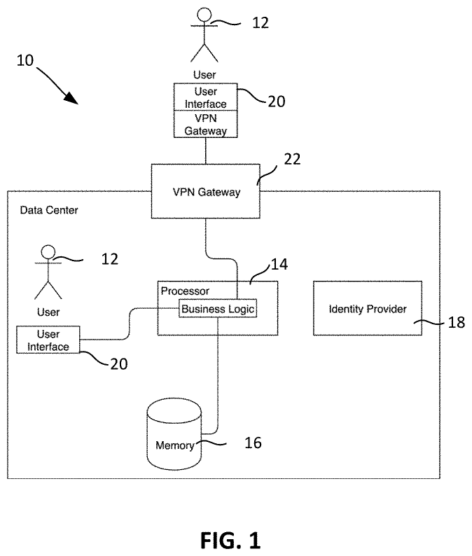

FIG. 1 illustrates a traditional Data Center Deployment 10 detailing how an organization would typically deploy an application to be used by actors 12, or for example, their employees. The Application typically would include a processor 14 which runs business logic, memory 16 which maintains state for the business logic, an identity provider 18 which determines which user is interacting with the business logic, and a user interface 20 with which users may interact with the application. Typically a virtual private network (VPN) 22 is used to provide access, which provides all-or-none access. The business logic associated with the application is intended to provide logic to determine which actions users can perform and which actions they do not have authorization. All components of the application aside from the user interface typically run within the data center. Typically the application uses many services internal to the Data Center without regard to identity or authorization since it is treated as a trusted environment.

In the traditional data center deployment, a user may access the application through one of two methods:
i. by using a user interface physically located within the data center; or,
ii. by using a user interface connected to the data center through a Virtual Private Network Gateway.

If the application understands identity, the user typically supplies it using only a single source of identity: the organization's identity provider, and each application individually operates on this in a unique fashion.

Authorized users for applications may include both humans and other computer systems. In particular, humans may perform actions directly, or actions may be performed on behalf of a human user by another computer system, or, may be computer to computer actions. Collectively this set of Users may be referred to as Identities, and the methods by which their Identities are made known are generally referred to as Identity Providers.

Embodiments of the system and method detailed herein are intended to identify, authenticate and authorize a user of an application. The authorization data may be retrieved from a database, and access control may be enforced by the system, both for the user to the application, and, from the application to any additional services or databases the application may need. Each network connection or session is intended to be individually identified and authenticated. Each network connection may be individually authorized based on the User's Identity, the User's role(s) within the Application, any Rules within the application that are Application-specific in nature and attach to zero or more roles. In some cases, a user may have zero roles in that the system can identify the user but the user is not configured for the Application. The system is intended to perform Identity, Role, and Authorization on behalf of an Application.

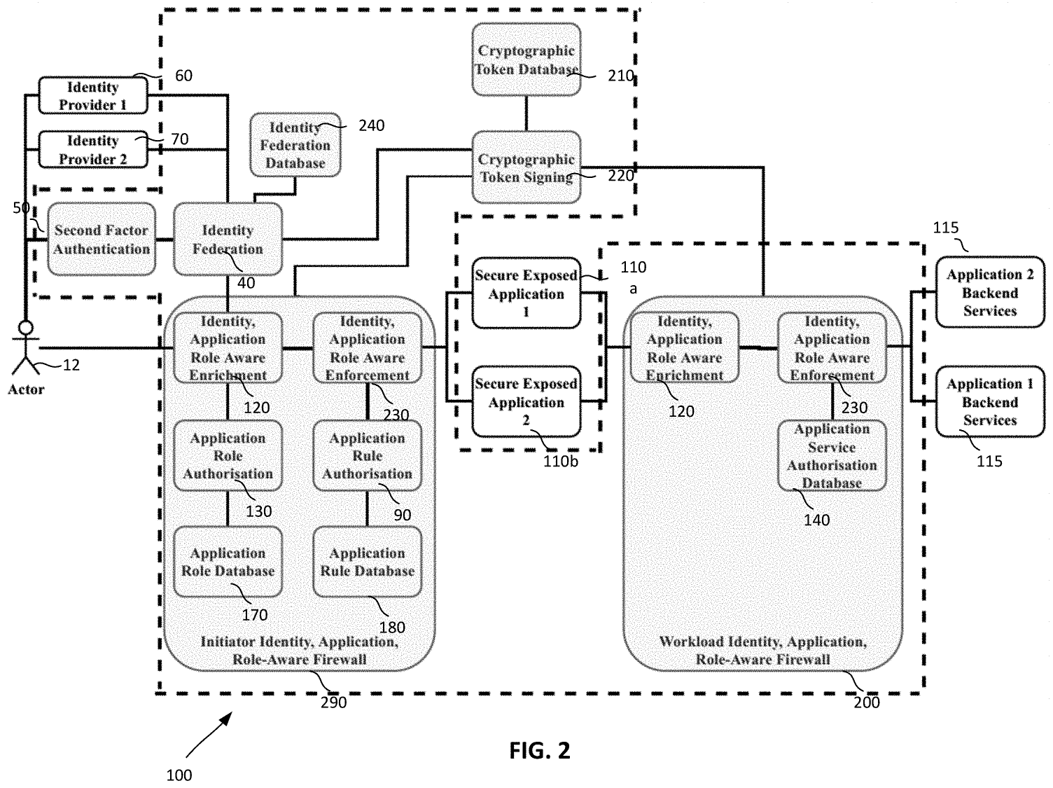

FIG. 2 illustrates a system 100 for identity and authorization management's interactions with its environment. A User or Actor 12, which might be a person, or may be another computer system wishes to perform an action on an application. The Actor 12 has an intrinsic identity of who it is, which is independent of what actions it is allowed to take, or what data it is allowed to access. The intrinsic identity of the Actor is intended to be a property of the Actor itself, for example, the person itself rather than the name it identifies by, or the like.

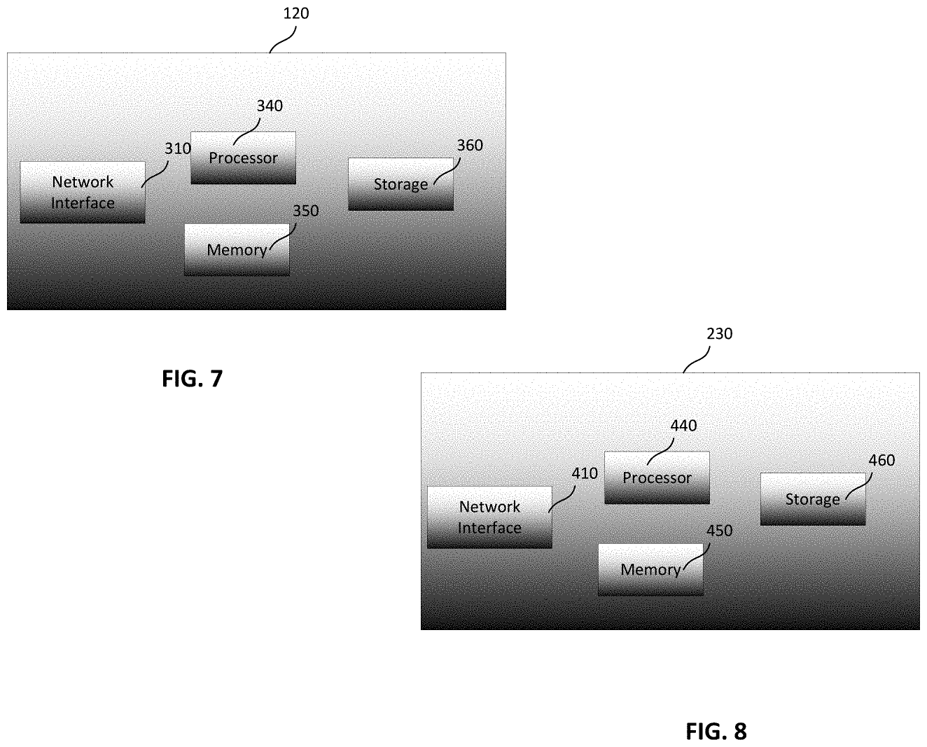

A system 100 for identity and authorization management includes an Identity, Application, Role-Aware Enrichment System 120, otherwise referred to as an Identity, Application, Role-Aware Enrichment Module. The Identity, Application, Role-Aware Enrichment system is shown in further detail in FIG. 7. The Identity, Application and Role-Aware Enrichment System 120 is configured to interact with an Identity of the upstream Actor 12. The Identity, Application and Role-Aware Enrichment System 120 is configured to determine, for example, via an Application Role Authorization System 130 an Authorization of the Actor, based on its Identity. Based on the data retrieved, the Identity, Application and Role-Aware Enrichment System 120 may make a decision, in conjunction with an Identity Federation 40 and a Cryptographic Token Signing system 220 to create an Access Token. An Access Token is a cryptographically signed set of assertions, encoded in, for example, JavaScript Object Notation (JSON) Web Token or other format. If the Identity, Application, Role-Aware Enrichment System 120 issues an Access Token, the Identity, Application and Role-Aware Enrichment System 120 may enrich the network messages of the Actor 12 with this Token, for evaluation by downstream systems such as an Identity, Application, Role-Aware Enforcement System 230. The Identity, Application, Role-Aware Enforcement System 230 shown in further detail in FIG. 8, receives messages from the upstream Actor, either directly or indirectly after being reviewed by modules or system detailed herein. The message may be received, via a Network Interface 410 and stores the message in Memory 450 (shown in FIG. 8). Further, the Processor of the Identity, Application, Role-Aware Enforcement System 230 retrieves the messages and performs the above processing regarding Identity.

A system 100 for identity and authorization management further includes an Application Role Authorization System 130. The Application Role Authorization System 130 is configured to determine the Roles of an Identity from an Application Role Database 170.

A system 100 for identity and authorization management may further include or be associated with the Application Role Database System 170. This database system is responsible for storage and retrieval of Roles by Identity, or by Application. Roles can be stored as strings (for example, “Owner”, “Editor”, “Viewer”) and may be dependent on the associated Application. The Application Role Database system 170 is intended to have a storage component that may be pre-populated with the Roles associated with each particular Application. Roles may be indexed by both Application and by Identity, allowing efficient retrieval of either a list of Roles per Application, or, a list of Roles per Identity. It will be understood that other forms of storage or other manners of indexing the data may be used.

A system 100 for identity and authorization management may further include the Identity, Application, Role-Aware Enforcement system 230. The Identity, Application, Role-Aware Enforcement system 230 is configured to determine or retrieve an Access Token, which may be present via either the Identity, Application, Role-Aware Enforcement system 230 or placed there by the Actor 12, comparing the validity of the Access Token via the Cryptographic Token Signing system 220, and via internal assertions within the Access Token. If these are confirmed, the Identity, Application, Role-Aware Enforcement system 230 is configured to determine or retrieve those assertions in an Application Rule Authorization System 90 to find the set of Application Rules which may apply. The Identity, Application, Role-Aware Enforcement system 230 may match the message from the Actor, the Role of the Actor (for example, as present in the internal assertions of the Access Token), and the valid set of Rules for that Role. If the message is matched, the Identity, Application, Role-Aware Enforcement system 230 is intended to take the given action (which might include, for example, ALLOW, DENY, or the like). If the message is not matched the Identity, Application, Role-Aware Enforcement system will DENY.

In some cases, the match criteria may include any application-specific fields. An example for an HTTP-based application is detailed herein and may include assertions regarding HTTP method (examples include GET, PUT, POST), HTTP paths (examples include/, /pictures, or the like), HTTP parameters (examples include ?uid=10, ?report=timesheet, or the like), HTTP body fields (examples would include, for MIME-type application/JSON, matching uid=don in {“uid”: “don”, “docfield1”: 9}, or the like). Other applications may have application-specific fields (for example, email might have FROM address, TO address, and the like or Remote Procedure call may have one or more of a Method, at least one Parameter, and a Body).

The system 100 for identity and authorization management may further include the Application Rule Authorization System 90. The Application Rule Authorization System 90 may be configured to determine or retrieve an Application Rules from an Application Rule Database 180, using the Role of the Actor 12 as provided by the Identity, Application, Role-Aware Enforcement System 230.

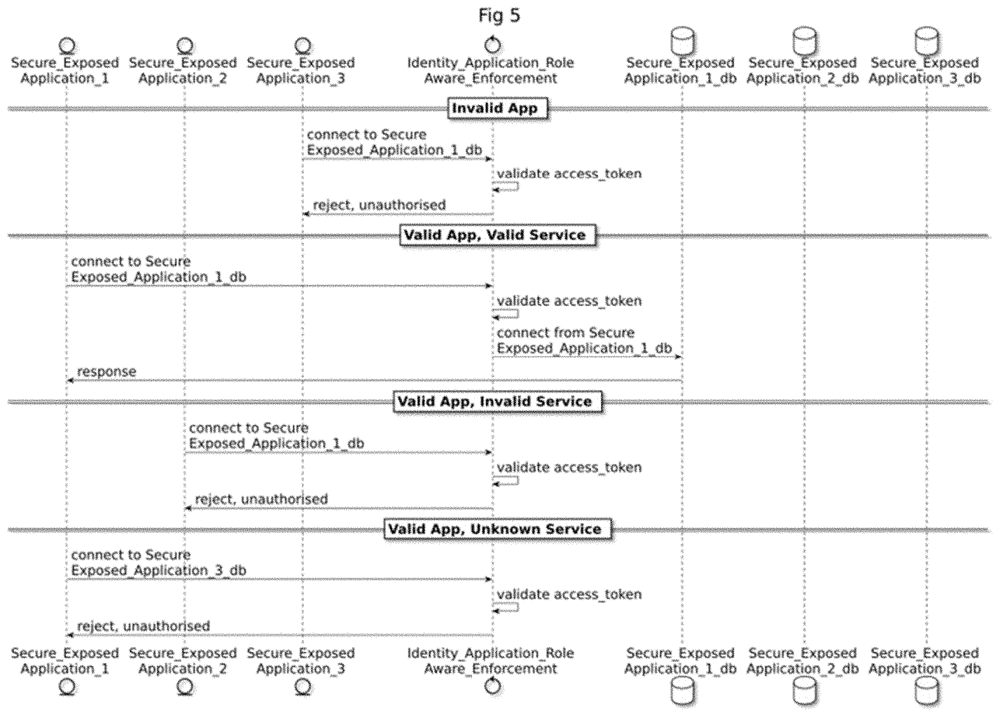

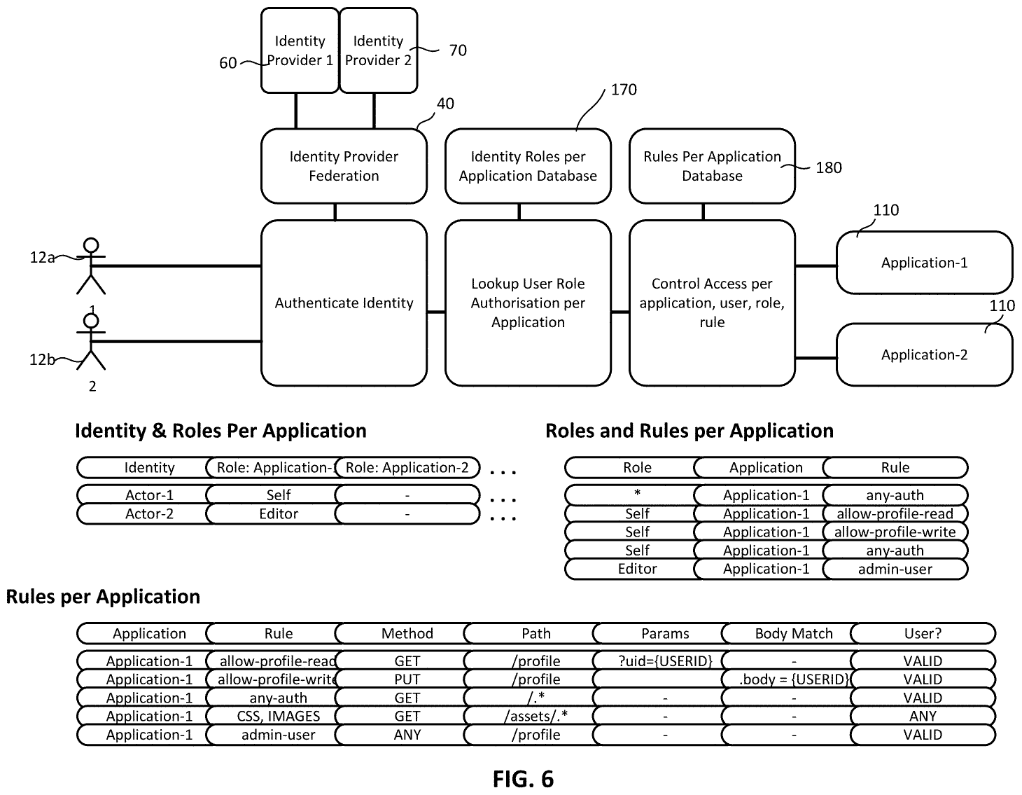

The system 100 for identity and authorization management may further include or be operatively connected with the Application Rule Database 180. The Application Rule Database 180 may have a similar internal components to the other systems, in that it receives messages from a network interface, these messages may be stored in memory and acted upon by a processing unit, for example a Central Processing Unit (CPU). The Application Rule Database 180 is further intended to include a storage component in which to store the data associated with the Application Rules. The Application Rule Database 180 contains data allowing an efficient lookup of a Role to a set of Application Rules, and contains data structures similar to those shown in FIG. 6. The Application Rule format varies by application, the example shown is for HTTP-based applications, although it will be understood that different formats are available.

Collectively, the set of systems which are involved in the lookup of an Actor's Identity, the Actor's Roles within the requested Application, the Rules associated with that Role in the Application, is shown as an Initiator Identity, Application, Role-Aware Firewall 290. As the Firewall includes various application and identity aware systems and modules, the firewall is intended to be considered an application-aware firewall as well as an identity-aware firewall. Further, The system 100 for identity and authorization management includes a plurality of sub-systems or modules, for example the an Identity, Application, Role-Aware Enrichment module 120 and the an Identity, Application, Role-Aware Enforcement module 230 as detailed herein. The modules may be referred to as systems herein, as each module is intended to include at least a processor or CPU, a memory component and a network interface configured to receive messages from at least one other module or system and send messages to at least one other module or system.

FIG. 2 further illustrates an Identity Federation 40. The Identity Federation 40 is configured to present the Actor 12 with a choice of how to prove the Actor's Identity (for example, logging in). The Identity Federation 40 is configured to store and retrieve from Identity Federation Database 240 the cryptographic and identity flow state associated with the Actor 12 logging in. The Identity Federation 40 is responsible for issuing an Identity Token (which is a cryptographic representation of the Identity of the Actor 12), for issuing the Access Token (in conjunction with Identity, Application, Role-Aware Enrichment System 120). The Identity Federation 40 may also be responsible for creating a trust relationship with one or more Identity Provider 60, 70 which may be internally or externally run. The Identity Federation may further be configured to decide whether the Actor 12 is required to provide additional proof of identity in the form of a Second Factor Authentication System 50. The Identity Token is intended to identify the Actor, while the Access Token is intended to provide further detail the Actor's current roles derived from the Actor's identity from the Identity Token.

An Identity Provider is a system which is configured to maintain a list of known Identities, and allows Actors to authenticate and claim or be associated with a particular Identity. For example, Identity Providers might include a corporate network Microsoft Active Directory, a Social Network Provider like Facebook or Google, or the like. Identities may look like email addresses (user@provider), or may use other Identity Provider specific identifiers. Choosing to trust an Identity Provider involves configuration of shared configuration within both the Identity Provider and within the Identity Federation. This configuration is proprietary to each Identity Provider, and typically includes a Client ID, a Client Secret, a Web Redirect Universal Resource Identifier, and the like. In an example, the Client ID may be a string representing the name of the Identity Federation, the Client Secret is configured such that the Identity Federation can access fields of the Identity, and the Web Redirect Universal Resource Identifier may be provided such that the Identity Provider may prevent other Identity Federation systems from using the same configuration.

In FIG. 2, the Second Factor Authentication System 50 is configured to issue a challenge to the Actor 12 to prove the Actor is in possession of a pre-known device, or, the Actor is intrinsically a particular identity (using, for example, Biometrics, Mutual Cryptographic Client Certificates, or the like). The challenge is intended to be a second level of identity verification, which is intended to allow the Actor to assert an Identity in a manner unrelated to a password. The Actor 12 may be required to prove the intrinsic identity (for example, by providing proof that the Actor has the Biometric or Mutual Client Certificate public key) information or possession of a pre-known device (for example, by providing a code which constantly changes on that device) by the Identity Federation 40 based on a set of conditions which might include which Identity Provider, time of day, network address they are originating from, type of device they are using, Application or Role they are requesting, or other information that may be important in deciding security and identity.

The Identity Providers 60, 70 are Systems which provide storage of Identities, which may be claimed by the Actor 12 in pre-arranged method. Methods may include, for example, username/password, Pre-Shared Cryptographic Identity, Biometric, or other mutually agreeable means of asserting and proving Identity.

In FIG. 2, Secure Exposed Applications 110a and 110b are Applications that an Actor 12 is desiring to use. The Secured Exposed Applications 110 provides access to information or other services that are specific to its domain. The Secured Exposed Applications 110 may be used via a network and the HTTP protocol, or any other method.

In FIG. 2, the Cryptographic Token Signing system 220 is shown. The Cryptographic Token Signing system 220 is configured to sign Identity Tokens, Access Tokens, and any other mutual cryptographic data. The Cryptographic Token Signing system 220 can be used to confirm data is signed by it by making its public key available on an interface The Public and Private key of the Cryptographic Token Signing system are intended to be configured by an operator of the system 100 for identity and authorization management. The Cryptographic Token Signing system 220 may also be used to confirm signing by passing the data from any one of the other modules or system of the System for identity and authorization management 100 to the Cryptographic Token Signing system 220 and requesting confirmation. The Cryptographic Token Signing system 220 may also revoke signing on previously issued information. The Cryptographic Token Signing system 220 is configured to use a Cryptographic Token Database 210 to store and retrieve public and private encryption keys, as well as logging actions taken and currently valid Tokens.

The Cryptographic Token Database 210 is responsible for storing public keys, private keys, issued tokens, timeouts, audits, logs, and the like associated with the Cryptographic Token Signing System 220. The Cryptographic Token Signing System 220 is intended to include at least a Network Interface, a Memory component, a central processing unit or similar processing unit and Storage.

In FIG. 2, the Application Service Authorization Database 140 configured to provide a storage and retrieval of Authorization rules as to which Secure Exposed Applications 110 may access which Application Backend Service 115 and optionally, on behalf of an Actor. In this fashion an Actor may be, via its Identity, and Role, granted access to an Application, and, the Application may be granted access to underlying data or service.

In FIG. 2, the collection of Identity, Application, Role-Aware Enrichment system 120 and Identity, Application, Role-Aware Enforcement system 230, when applied to the Workload of the Secure Exposed Application 110 and any Application Backend Services 115 may be referred to as a Workload Identity, Application, Role-Aware Firewall 200. As the firewall includes various application and identity aware systems and modules, the firewall is intended to be considered an application-aware firewall as well as an identity-aware firewall. Further, as the fire-wall includes further aspects with respect to workload and may further be a workload aware firewall.

In FIG. 2, the Application Backend Services 115 are intended to be services, optionally over a network, which the Secure Exposed Applications 110 may require, accessing either on behalf of an Actor, or, accessing directly the needs of the Application Backend Service. These services may include, for example, a database, email server, or other Application-specific service.

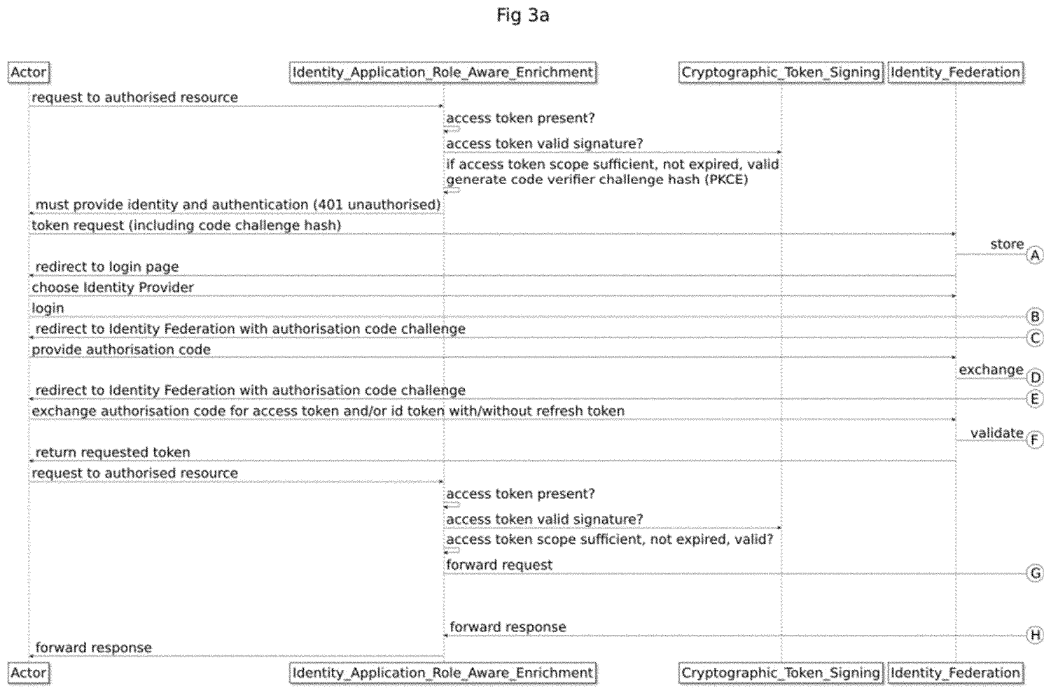

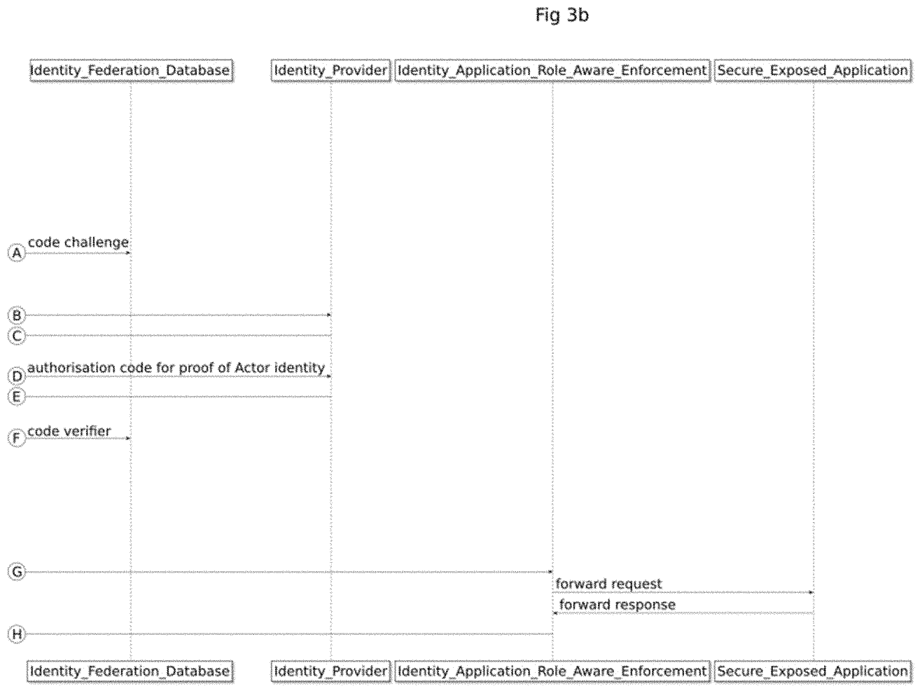

As shown via the system in FIG. 2 and the sequence diagram in FIG. 3, the Actor 12, which might be a person, or may be another computer system, attempts to use the Secure Exposed Application 110 over a network connection. This network request first arrives at an Initiator Identity, Application, Role-Aware Firewall 290 where the request is received by the processor and stored in memory. The Initiator Identity, Application, Role-Aware Firewall 290 may be split into a plurality of computer systems for technical reasons, which could include performance, reliability, geographical considerations, or the like. In this embodiment, the network request would be received by an Identity, Application Role Aware Enrichment 120 device via the associated network interface, and stored in an associated memory, to be acted on by the processor. The Initiator Identity, Application, Role-Aware Enrichment system 120 may examine the request to see if it contained an Access Token, and if so, compare the cryptographic signature against the signing keys from the Cryptographic Token Database 210 via the Cryptographic Token Signing 220 system.

If no Access Token is present, or, if the Access Token is present but invalid, expired, revoked, or the like, the Identity, Application, Role-Aware Enrichment system 120 may then issue a challenge to the Actor 12 to provide its Identity and Authenticate, via Identity Federation 40 which might in turn allow the Actor 12 to choose one of a set mutually acceptable Identity Providers 60, 70 to provide Identity and Authentication. The Identity Federation 40 may also be requested by the Identity, Application, Role-Aware Enrichment system 120 to require the Actor to provide a second-factor of authentication. This second-factor authentication might include a device only the proper Actor 12 would have possession of, or, might be some intrinsic property of the Actor 12 such as a Biometric, a pre-shared mutual cryptographic key, or the like. An embodiment of the method for Identity and Authentication is shown in the sequence diagram in FIG. 3.

To provide Identity and prove the Identity via Authentication, many methods exist, including but not limited to Security Assertion Markup Language, Open Authentication, and the like. In FIG. 3, Identity and Authentication is demonstrated using OpenID Connect: Proof Key for Code Exchange by OAuth Public Clients with the Systems of FIG. 2. In this implementation, the Actor 12 attempts to access a resource which requires authorization. The Identity, Application, Role-Aware Enrichment system 120 checks that an Access Token is present, valid, not-expired, and validly signed by a Cryptographic Key trusted by Cryptographic Token Signing 220 and its Cryptographic Token Database 210. If the Access Token is not present, or not valid, the Identity, Application, Role-Aware Enrichment system 120 may generate a code verifier challenge hash, and return an unauthorized redirect to the Actor 12. The Actor 12 is intended to be redirected to the Identity Federation 40, providing this code verifier challenge hash. The Identity Federation 40 will store this code verifier hash in the Identity Federation Database 240 for later confirmation. The Identity Federation 40 will present the Actor 12 with a set of pre-configured acceptable Identity Providers 60, 70. The Actor 12 may choose any one of these Identity Providers, and then present their login credentials to the Identity Provider 60, 70. Once the Identity Provider accepts the login credentials, the Actor 12 will be redirected back to the Identity Federation 40 where the challenge code hash will be confirmed. It will be understood that although only two Identity Providers are shown in FIG. 2, any number of Identity Providers could be selected.

With the Actor 12 identified securely, the Identity, Application, Role-Aware Enrichment system 120 will retrieve the Actor's Application Role Authorization 130 from the Application Role Database 170. If the Actor 12 has one or more valid roles in the Application Role Database 170, an Access Token will be issued and returned.

If the Actor 12 has zero valid roles in the Application Role Database 170, no Access Token is issued, and an unauthorized message is returned.

If the Actor 12 has one or more valid roles, and an Access Token was issued, the Actor 12 may then re-request the authorized resource from the Secure Exposed Application 110 On this attempt, with a valid access token, the Identity, Application, Role-Aware Enrichment system 120 will validate and forward the request to the Identity, Application, Role-Aware Enforcement system 230. The Identity, Application, Role-Aware Enforcement system 230 is intended to confirm the request is from a valid Identity, Application, Role-Aware Enrichment system 120 via mutual cryptography. The Identity, Application, Role-Aware Enforcement system 230 will then verify the Access Token. Once verified, the Identity, Application, Role-Aware Enforcement system 230 will determine or retrieve the resource request in Application Rule Database 180.

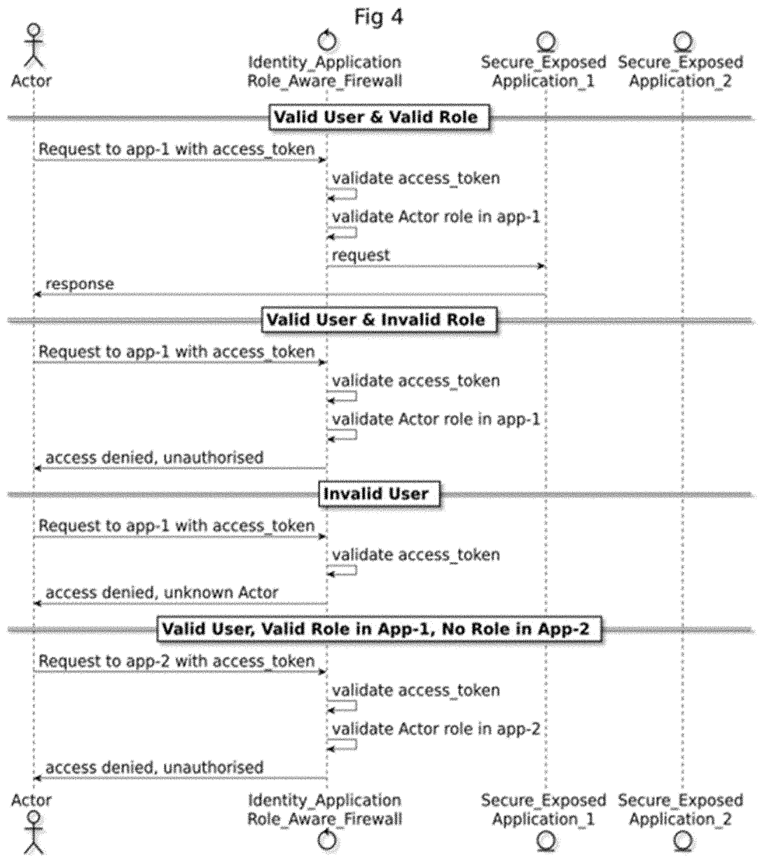

Expanding on the method for identity and authorization management illustrated in a sequence diagram in FIG. 4, the Actor 12 makes a request to Secure Exposed Application 110 with a valid Access Token, containing one or more valid roles. The Initiator Identity, Application, Role-Aware Firewall 290 validates the Access Token using the Cryptographic Token Signing 220. The Initiator Identity, Application, Role-Aware Firewall 290 then validates that the Actor has a valid role in the Secure Exposed Application 110 via the Application Role Database 170. If these are both valid, the Request is forwarded towards the Application.

In FIG. 4, if the Actor 12 makes a request to the Secure Exposed Application 110a with a valid Access Token, containing no roles or an invalid role (as determined by, for example, a look up in Application Role Database 170) the request is returned as unauthorized.

In FIG. 4, if the Actor 12 makes a request to the Secure Exposed Application 110a with an invalid Access Token (as determined by, for example, a look up in the Cryptographic Token Signing 220), the request is returned as unauthorized.

In FIG. 4, if the Actor 12 makes a request to the Secure Exposed Application 110b, with an Access Token indicating a valid User and valid Role in Secure Exposed Application 110a, but no valid Role in Secure Exposed Application 110b, the request is returned as unauthorized.

FIG. 6 illustrates an example of a plurality of Application Rules. Applications may have no rules, or may have at least one rule in the Application Rule Database 180. These Rules are sets of, for example, Request methods, Paths, Parameters, Message Body Patterns, valid Users, Client Certificates, and other Application-specific match criteria. An Actor, for example a User 12a or 12b, upon proving their Identity, and having a set of Roles, sends a Request, and the system for Identity and Authorization Management must now verify if the Request is valid for the Roles each Actor may have. For each Request, the Actor is presenting an Identity and Role. The Application has a set of Roles the Application will accept, and each Role has a set of Rules. The Request is matched against the list of Rules, constrained by the Roles the Actor has, until either a match is made, or no match can be made. Rules are matched in an application-specific fashion, an example method for HTTP-based applications is shown in FIG. 6, using the databases 170 and 180 to store the roles and rules respectively.

Referring to the data-structures of FIG. 6, the Identity of the Actor can be seen and is intended to allow for retrieving, securely, one or more Roles, per Application. These Roles may then be expanded to sets of Rules, which each request can be matched against.

Each Secure Exposed Application 110 may in turn have other network systems they access on behalf of the Actor 12. In an analogous pattern of how the Actor 12 may prove and authenticate its identity, and the Initiator Identity, Application, Role-Aware Firewall 290 confirms this, a similar method may be performed on identity-based firewall on the Workload of each Secure Exposed Application to other aspects of its Workload. Identity of a Secure Exposed Application may be assigned using cryptographic assertions, enriched on the requests using methods such as JSON Web Tokens, and confirmed via Cryptographic Token Signing 220 and Cryptographic Token Database 210. A request flows from a Secure Exposed Application 110 towards an Application Backend Service 115. The request may be enriched with the Identity of the Secure Exposed Application 110 via the Identity, Application, Role-Aware Enrichment System 120. The requests may flow through the network where it is received by the processor of Identity, Application, Role-Aware Enforcement System 230 into the memory component. The Enriched request has its identity confirmed via Application Service Authorization Database 140 and a decision is made as to whether to forward the request towards the Application Backend services 115 or to deny it as unauthorized.

Expanding on this, in FIG. 5, an example of authorization flows that operate on Workload identity are shown. The workload identity of the Secure Exposed Application 110 may or may not be derived from the original Actor 12 identity. On receipt of a request, Identity, Application, Role-Aware Enrichment 120 adds the Identity of the Secure Exposed Application to the header, or metadata, or any of a multitude of request-specific methods. This request is forwarded through the network where the request is intended to be retrieved by Identity, Application, Role-Aware Enforcement system 230.

FIG. 5 illustrates various example scenarios of the system and method for Identity and Authorization management. In the first example, as “Invalid app” of FIG. 5, Secure Exposed Application 3 attempts to access Secure Exposed Application 1 Database. The request is initiated by Secure Exposed Application 3. This is an unknown application, and it is not enriched by the Identity, Application, Role-Aware Enrichment system 120. The Identity, Application, Role-Aware Enforcement System 230 receives this request. The Identity, Application, Role-Aware Enforcement System 230 validates the enriched header via Cryptographic Token Signing system 220. There is either no header present, or, it was not validly signed on the request, and the request is returned unauthorized.

In the second example, “Valid App, Valid Service” of FIG. 5, Secure Exposed Application 110 attempts to access Secure Exposed Application 1 Database. The request is initiated by Secure Exposed Application 1. The Identity, Application, Role-Aware Enrichment system 120 enriches the request with the Identity of Secure Exposed Application 1 and forwards onwards to the network. The Identity, Application, Role-Aware Enforcement 230 receives this request and validates the enriched header via Cryptographic Token Signing system 220. If not valid, the Identity, Application, Role-Aware Enforcement 230 returns that the request is unauthorized. If valid, the Identity, Application, Role-Aware Enforcement 230 looks the header up in Application Service Authorization Database 140. In this example, the Application Service Authorization Database 140 has an entry indicating Secure Exposed Application 1 can access Secure Exposed Application Database 1, and the request is forwarded to Secure Exposed Application Database 1 transparently.

In the third example, “Valid App, Invalid Service” of FIG. 5, Secure Exposed Application 2 attempts to access Secure Exposed Application 1 Database. The request is initiated by Secure Exposed Application 2. The Identity, Application, Role-Aware Enrichment system 120 enriches the request with the Identity of Secure Exposed Application 2 and forwards onwards to the network. The Identity, Application, Role-Aware Enforcement system 230 receives this request and validates the enriched header via Cryptographic Token Signing system 220. If not valid, the Identity, Application, Role-Aware Enforcement system 230 returns the request as unauthorized. If valid, the Identity, Application, Role-Aware Enforcement system 230 looks the header up in Application Service Authorization Database 140. In this example, the Application Service Authorization Database 140 has no entry indicating Secure Exposed Application 2 can access Secure Exposed Application Database 1, and the request is denied as unauthorized. The Application Service Authorization Database 140 is intended to be pre-populated and updated by an administrator of an organization which owns the Secure Exposed Application.

In the fourth example, “Valid App, Unknown Service” of FIG. 5, Secure Exposed Application 1 110a attempts to access Secure Exposed Application 3 Database. The request is initiated by Secure Exposed Application 1. The Identity, Application, Role-Aware Enrichment system 120 enriches the request with the Identity of Secure Exposed Application 1 and forwards onwards to the network. The Identity, Application, Role-Aware Enforcement 230 receives this request and validates the enriched header via Cryptographic Token Signing 220 as detailed herein. If not valid, The Identity, Application, Role-Aware Enforcement 230 returns that the request is unauthorized. If valid, the Identity, Application, Role-Aware Enforcement 230 looks the header up in Application Service Authorization Database 140. In this example, the Application Service Authorization Database 140 has no entry indicating for Secure Exposed Application Database 3, and the request is denied as unauthorized.

FIG. 7 illustrates the Identity, Application and Role-Aware Enrichment system 120 in greater detail. The system 120 includes at least one network interface 310, at least one processor 340 and at least one memory component 350, and a storage component 360. The system may reside in a single network device, or may be distributed across more than on device. The at least one network interface 310 of the Identity, Application and Role-Aware Enrichment system 120, is configured to receive network messages from an actor or system and are intended to be saved by the memory 350 and processed by the at least one processor 340. These messages are intended to be enriched by the system 120 based on the Identity and authorization of the actor associated with the message to provide for downstream access control. The system and modules, including the processor 340, memory 350 and storage 360, are in communication with each other but may be distributed over the network.

FIG. 8 illustrates the Identity, Application, Role-Aware Enforcement system 230 in greater detail. The system 230 includes a network interface 410, at least one processor 440 and at least one memory component 450, and a storage component 460. The at least one network interface 410 of the Identity, Application and Role-Aware Enforcement system 230, is configured to receive network messages from an actor or system and are intended to be saved by the memory 250 and processed by the at least one processor 440. The messages are intended to be reviewed and the roles and associated rules for the actor and or the secured application are intended to be enforced based on the determined identity and authorization, as detailed herein. The system may reside in a single network device, or may be distributed across more than on device. The modules, including the processor 440, memory 450 and storage 460, are in communication with each other but may be distributed over the network.

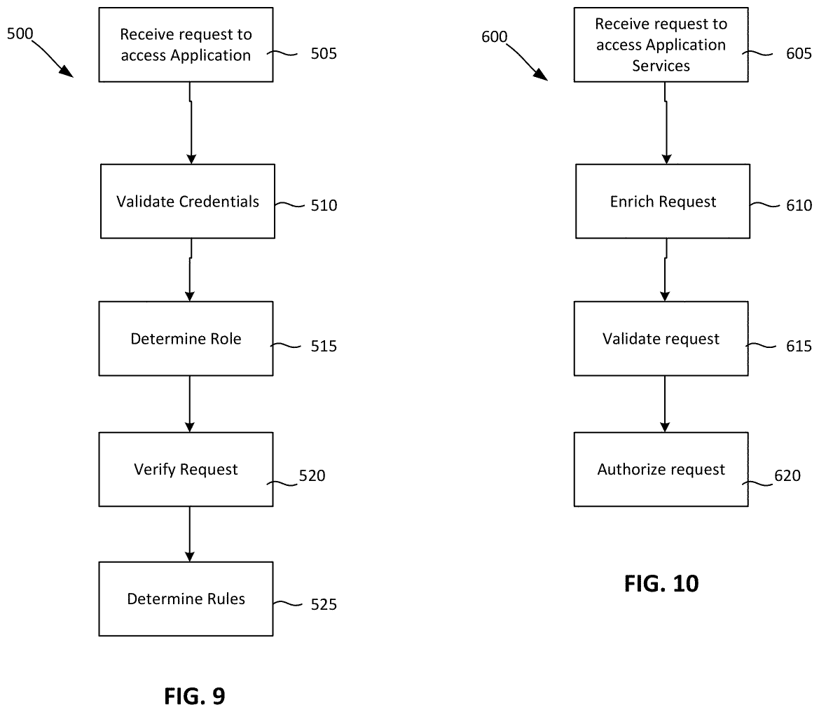

FIG. 9 illustrates an embodiment of a method 500 for identity and authorization management according to an embodiment. The Initiator, Identity, Application, Role-Aware firewall 290 receives a request, at 505, from a User to access an application. The Identity, Application, Role-Aware Enforcement system 230 validates the user's credentials, at 510, and may require the user to provide and authenticate its identity via an Identity Federation and/or Identity Provider. At 515, the Application Role Authorization system 130 may determine the user's role associated with the Application. Once the Role and identity has been determined, the system may verify the request, at 520 and determine the rules associated with the request at 525.

FIG. 10 illustrates an embodiment of a method 600 for identity enrichment according to an embodiment. The Identify, Application and Role-Aware Enrichment system 120 receives a request to access an application service at 605. At 610, the Identify, Application and Role-Aware Enrichment system 120 enriches the request with the identity of the Secure Exposed Application 110. At 615, the Identity, Application, Role-Aware Enforcement system 230 validates the request, with for example, the review of the Application Service Authorization database 140. At 620, the Identity, Application, Role-Aware Enforcement system 230 authorizes the request or returns that the request is not authorized.

Embodiments of the system and method detailed herein are intended to apply both identity and authorization in the data path on behalf of an application. Conventional solutions relied on identity being provided to the application and the application typically decides internally what to do, or, a very simple firewall/VPN provided a Boolean authorization to the application. Embodiments of the system and method are intended to provide for various levels of authorization, for example, user A has access to their own records but not other users, user B can read/write all user records but not delete them, and the like.

Further, embodiments of the system and method detailed herein are intended to provide identity and authorization flows from the user and front end of the application to one or more backend resources. For example, the application has a web server the user interacts with but the interactions may further cause actions on an associated database. This workload identity and authorization is intended to be associated with the identity and proper authorization from both the front end of the application and the back end of the application.

Embodiments of the system and method may provide for access control to be performed in one spot, or, the information can be stamped in the network connection (as a header or metadata) in a cryptographically-secure fashion (for example, using a JSON Web Token, JWT) to be acted on downstream.

Embodiments of the system and method are intended to provide for access per session per resource per role, which is unlike a traditional VPN connection. Further, being granted access to one resource and/or role will not automatically grant access to another resource and/or role, via this system.

Embodiments of the system and method are intended to be configured to various protocols. In some cases, applications being accessed by the system which the system will grant authorization and determine user role and rules associated with the roles may be Hypertext Transfer Protocol (HTTP) applications. In other cases, the applications might use Simple Mail Transfer Protocol (SMTP). In still other cases, the application may use a remote procedure call, for example gRPC, Simple Object Access Protocol (SOAP), or the like. Other protocols may also be used by the applications accessed by the users, via the system and method for identity and authentication management.

Embodiments of the system and method are intended to provide for an identity-aware firewall as detailed herein. It will be understood that an Identity and/or User can be a person, or a system, on either the front-end or backend.

### Definitions

Application: A program providing functionality to Users.

User: An entity who uses at least one Application. Sometimes referred to as an Actor and may be a human or computer system.

Identity: A unique collection of information about a User, which may be used by components of the System to control their operation.

Authentication: The act of determining the Identity of a User.

Authenticated: A User is Authenticated if the system has determined their Identity.

Authorization: Determining whether a user is allowed to perform an operation.

Authorized: An operation is Authorized if the user is allowed to perform it.

Operation: an action requested of an Application by a User.

Identity Provider: A component that validates the Identity of a User.

Federated Identity Provider: An Identity Provider which validates the Identity of a User based on the validation provided by other Identity Providers.

Virtual Private Network (VPN): A Private Network extending across more than one Data Center. Typically enabled by a Secure Network Tunnel between a gateway located in each Data Center.

Network Address: a value used to locate a device on a network.

OpenID Connect (OIDC): A protocol by which one system may verify (and retrieve profile information about) the identity of a user based on the authentication credentials provided by another system.

Workload: an instance of an application or service.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments or elements thereof described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art witho

[symbol]

What is claimed is:

1. A system for identity and authorization management of users on a computer network, the system comprising:
an Identity, Application and role-aware enrichment module configured to determine and authenticate an identity of a user and issue an access token;
an Identity, Application and Role-Aware enforcement module configured to determine access to at least one application and provide access to the user based on the access token;
a database configured to store authorization roles associated with the identity of the user and the at least one application; and
a database configured to store rules associated with the authorization roles.

2. The system according to claim 1, wherein the access token comprises the identity of the user and the authorization roles associated with the user.

3. The system according to claim 2, wherein the access token is a cryptographically confirmed access token.

4. The system according to claim 1, further comprising a second factor authentication module configured to issue an authentication challenge based on the identity of the user.

5. The system according to claim 1, further comprising an application aware firewall, wherein the firewall comprises rules associated with one or more of HTTP method, path, parameters, Client Certificates, HTTP headers, and message body.

6. The system according to claim 1, further comprising an application aware firewall, wherein the firewall comprises rules associated with remote procedure call applications and methods, parameters, and body associated with the remote procedure call applications.

7. The system according to claim 1, further comprising an identity aware firewall, wherein the firewall is configured to provide a plurality of levels of access to the user based on the identity of the user and the user authorization roles.

8. The system according to claim 1, wherein the at least one application is configured to use network services; and
the system further comprises:
a database configured to store network services authorization rules associated with each of the at least one applications; and
a workload-aware firewall configured to receive a request from the at least one application to access network services and to control access between the at least one application and the network services based on the identity of the user and the user authorization roles.

9. A system for identity and authorization management, the system comprising:
at least one application, accessible to a user via a computer network, wherein the at least one application is configured to use network services;
a database configured to store network services authorization rules associated with each of the at least one applications; and
a workload-aware firewall configured to receive a request from the at least one application to access network services and to control access between the at least one application and the network services.

10. The system according to claim 9, wherein the request is a cryptographically-confirmed token.

11. The system according to claim 9, wherein the workload-aware firewall is configured to control access to the at least one application and the network services based on a user identity and authorization data associated with the request from the at least one application.

12. The system according to claim 9, wherein the workload-aware firewall is configured to control access to the at least one application and the network services based on a user identity and the authorization rules associated with the at least one application.

13. A method for identity and authorization management, the method comprising:
receiving, via a user, a request to access at least one application;
determining an identity of the user;
authenticating the identity of the user by providing an access token associated with the request;
determining at least one role associated with the authenticated identity of the user;
determining whether any rules are associated with the access of the at least one application, based on the identity of the user and the associated role of the user; and
providing access to the at least one application based on the identity of the user and the associated roles and rules.

14. The method according to claim 13, wherein the access token comprises the identity of the user and the authorization roles associated with the user.

15. The method according to claim 14, wherein the access token is a cryptographically confirmed access token.

16. The method according to claim 13, wherein authenticating the user comprises issuing an authentication challenge based on the identity of the user.

17. The method of claim 13 further comprising:
receiving a second request from the at least one application to access at least one network service;
determining whether there is further user identity information to be added to the second request;
determine whether there are any network service authorization rules associated with the request; and
providing access to the at least one network service based on the application and associated authorization rules.

18. The method according to claim 13, wherein the second request comprises a cryptographically-confirmed token.

19. The method according to claim 13, wherein the providing of access may be further based on the authorization data of the user.
